(19) United States
(12) Patent Application Publication
(10) Pub. No.: US 2006/0170392 A1
(43) Pub. Date: Aug. 3, 2006

(54) Portable charging system

(75) Inventors: Kuo-Chan Huang, Taipei City (TW); Hui-Chang Chuang, Pan-Chiao City (TW)

Correspondence Address: BIRCH STEWART KOLASCH & BIRCH, PO BOX 747, FALLS CHURCH, VA, 22040-0747, US

(73) Assignee: SINBON ELECTRONICS COMPANY LTD.

(21) Appl. No.: 11/043,982

(22) Filed: Jan. 28, 2005

(51) Int. Cl. H02J 7/00

(52) U.S. Cl. 320/107

(57) ABSTRACT

A portable charging system capable of improving the traditional charging structure and technology uses a programmable function and a controller memory method in a charging and discharging system, which can simultaneously charge and discharge the charger of a mobile electronic device or the charger of the charging system itself, or continue supplying the existing battery power in the original circuit to a mobile electronic device. The portable charging system has a mobile electronic device charging output port, a power input port, a program update input port, a chargeable/dischargeable battery, and a main system printed circuit board. The foregoing mobile electronic device charging output port, power input port and program update input port has the following circuit modules: a charging/discharging interface module, a charging module, a discharging module, a battery control interface module and a control module.

### BACKGROUND OF THE INVENTION

1. Field of the Invention

The present invention relates to a portable charging system that improves the function of a traditional charging structure and the technology thereof. A controller memory method is adopted in the charging system for charging and discharging both charging system and discharging system of a mobile electronic device simultaneously by means of a programmable function or supplying an electric power from the original built-in battery of the original circuit to the mobile electronic device to meet the requirements for operating a mobile electronic device outdoors or in an indoor working area with other electric appliances. The present invention omits the adapter for a mobile electronic device, and thus can save the material cost of the adapter. The present invention is applicable for most mobile electronic devices and capable of enhancing the battery charging efficiency, giving a programmable effect, and offering longer battery operating hours.

2. Description of Related Art

As realized by related industries, enhancing the function of charging a mobile electronic device is a subject for mobile electronic device designers and a research and development topic for O.E.M. manufacturers in recent years. The technology and method adopted are similar to those used for automobile chargers or a new adapter connected to traditional power supplies, which are applicable for various different mobile electronic devices and meet the requirements for charging a battery. At present, an improved charging structure is a very important item, since most traditional charging assemblies come with a connector specifically designed for connecting to a fixed power supply, and any slight change may cause incompliance with the specification.

In general, an electric charging connector includes a universal serial bus (USB) port and a battery charger for PDAs and mobile phones. The market for USB connector assemblies has grown significantly in recent years. Since mobile electronic products tend to be lighter, thinner, shorter and smaller as time passes, charging equipment has become an industrial standard and involves long-hour battery operation technology. With the advancement of the small packaging technology, a small sized battery module creates a high demand for the charging module device, and also presents an excellent business opportunity to the power supply industry. To meet the requirements of mobile phones, communication products and other industries, the small charging module assembly is expected to continue its growth in the future.

Reference is made to FIG. 1. A prior-art mobile electronic device 1 (such as a notebook computer, a personal digital assistant or a mobile phone) has a charger socket 2 for connection to a universal serial bus (USB) connector 3 for transmitting data or charging a battery. The electronic device 1 is also connected to a power supply and a data source. The specifications of the traditional battery charger for electronic devices must be modified from time to time. Changes in specification can be overcome by using an adapter, but there are still problems for the specifications of voltage and current. For example, the connector is larger for an adapter that converts 5V into 3V, and the overall size becomes too big or an additional circuit (the circuit of the adapter) causes an excessive size as well. In practical applications, such arrangement affects the overall size and additional functions and adversely effect the yield rate of the connector.

### SUMMARY OF THE INVENTION

Therefore, it is a primary objective of the present invention to provide a charging device having an improved long operating hour feature and a programmable effect to be used in the battery charging method for most mobile electronic devices so as to lower costs and enhance quality.

To achieve the foregoing objective, the present invention uses a set of batteries connected in series as well as a protection circuit. The protection circuit is connected to a microprocessor unit (MCU), which can store a program, and the MCU further connects to a charging module and a discharging module. The charging and discharging modules are connected to an output module and an input module, respectively, for avoiding the issue of changing specifications of the traditional charging devices. With the structure of a basic main charging system and an expanded power subsystem, the function of charging and discharging a power supply is accomplished to economically define a battery charging assembly for practical applications. Therefore, the present invention has a higher practical value over the prior art, and also comes with an additional battery protection function.

The system and structure of the present invention are elaborated below. A basic main charging system comprises a mobile electronic device charge output port, a power input port, a program update input port, a chargeable/dischargeable battery, and a main system printed circuit board. The main system printed circuit board is coupled to the mobile electronic device charging output port, the power input port, the program update input port and the chargeable/dischargeable battery. The basic main charging system also comprises the following circuit modules. A charge/discharge interface module is coupled with the mobile electronic device charging output port and the power input port and has an input/output signal management function. A charging module is coupled with the charge/discharge interface module and has a charge signal management function. A discharging module is coupled with the charge/discharge interface module and is capable of managing a discharge signal. A battery control interface module is coupled with the chargeable/dischargeable battery, the charging module or discharging module and has a battery protection function. A control module has a memory and is capable of updating a control program through the program update input port.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view of a basic main charging system, for coupling to an expanded power subsystem, according to the prior art;

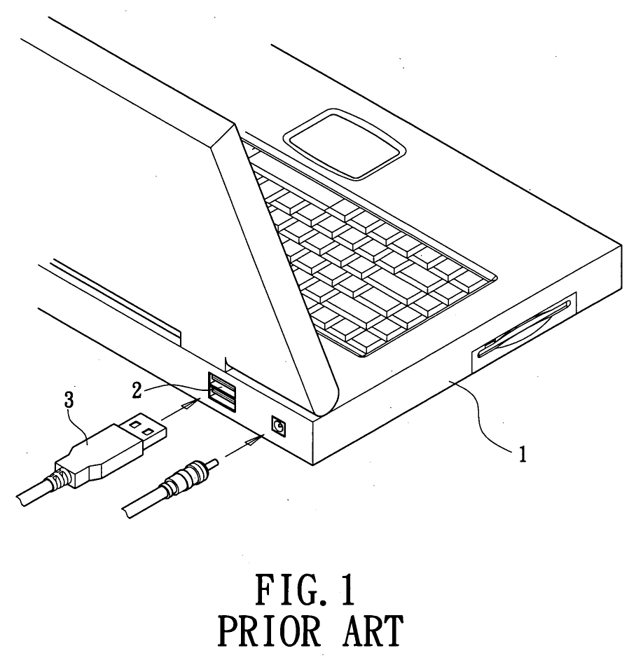

FIG. 2 is a top view of an expanded power subsystem according to the present invention; and

FIG. 3 is another top view of an expanded power subsystem according to the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or limited to the precise form disclosed.

Reference is made to the following description for the operating principle of the present invention. The present invention installs a program in the memory of the MCU to facilitate the charging/discharging flow for electronic devices in different occasions, and uses a simple way to describe the flow of the present invention. A program is saved in the MCU for testing a charging/discharging device. After the plug or the connector of an electric charger is connected, the charging or discharging operation for an electronic device is performed. The plug or connector can be an electronic device/charger connector and generally is a notebook DCIN. Therefore, it is easier for the present invention to cope with a change of specifications of an electronic device. With an expanded power subsystem, a charging/discharging system with a multiple of functions can be defined to meet the requirements of the required applications. Furthermore, the MCU can be connected to a simple voltage regulating circuit for the desired functions.

In the present invention, the whole set of batteries is connected in series and connected to a protection circuit, and the protection circuit is connected to a microprocessor MCU capable of storing a program. The MCU is further connected to a charging module and a discharging module, and the charging and discharging module are connected to an output/input module to avoid the issue of a fixed specification of the prior-art charging devices. With the structure of a basic main charging system and an expanded power subsystem, the function of charging/discharging a power supply is accomplished to economically define a battery charger for practical applications. Therefore, the present invention has a higher value over the prior art, and also comes with an additional battery protection function.

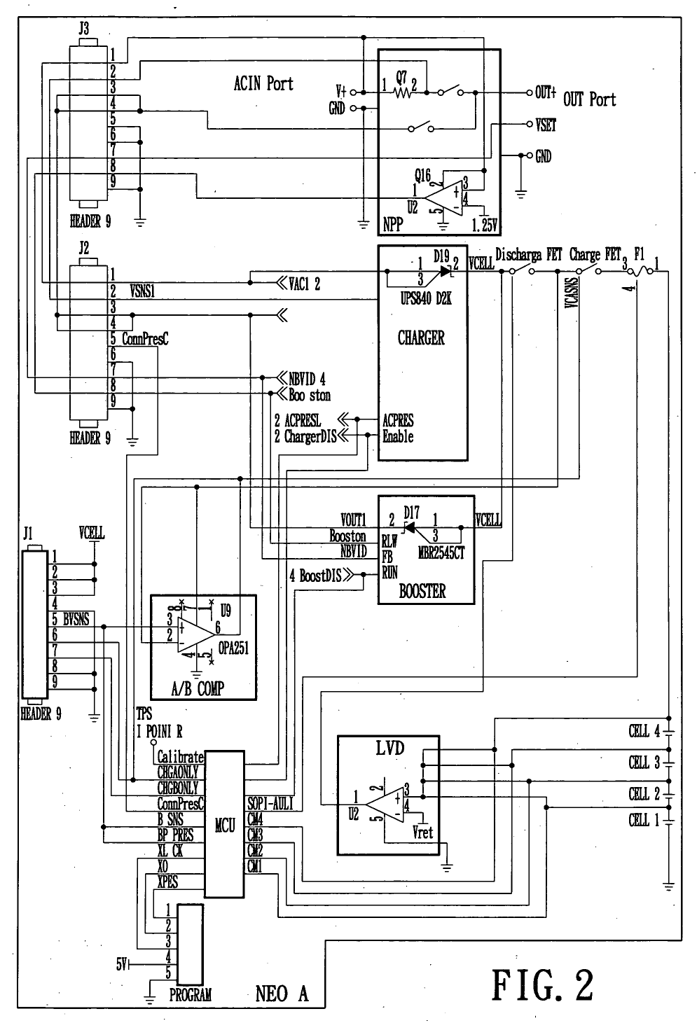

Reference is made to FIG. 2 for the architecture of the present invention, which comprises: a basic main charging system (NOE A) further comprising a mobile electronic device output port (OUT Port including three contact points OUT+, VSET, GND, where VSET is the voltage testing contact point for controlling the voltage output); a power input port (ACIN Port including V+ and GND contact points); a program update input port (PROGRAM, 1-5 contact points); a chargeable/dischargeable battery (CELL1 to CELL4); a main system printed circuit board connected to the circuits of the foregoing mobile electronic device output port (OUT Port), the power input port (ACIN Port), the program update input port (PROGRAM) and the chargeable/dischargeable battery (CELL1 to CELL4). The present invention also comprises the following circuit modules: a charge/discharge interface module (NPP, having a charging resistor R7 and a comparator U2) coupled to the mobile electronic device output port (OUT Port) and the power output port (ACIN Port) and capable of managing the input/output signal (power supply signal); a charging module (CHARGER including a single-phase current limit diode D19, a power supply input signal ACPRESS, a charging enable value ENABLE) being coupled to a discharge interface module (NPP) and capable of managing the electric signals; a discharging module (BOOSTER including a reference voltage feedback value NBVID, a discharge enable signal Booston, a discharge setting RUN, a discharge output VOUT1, a current regulating diode D17) coupled to the discharge interface module (NPP) and capable of managing the electric signal; a battery control interface module (LVD including a comparator) coupled to the chargeable and rechargeable batteries (CELL1 to CELL4), the charging module or the discharging module (CHARGER, NPP) and capable of maintaining the power level of the battery; and a control module (MCU connected to the parallel battery contact point CM1-CM4, the discharging module contact points SOPI-AULI, the program update input port contact points XL-CK, XO, XRES) for connecting the system port (J1-HEADER), the CHGAONLY, CHGBONLY and B SNS connected to the expanded power subsystem (NEO B), and the BP PRES, ConnPresC connected to J2-HEADER, and having a memory and capable of updating a control program through the program update port.

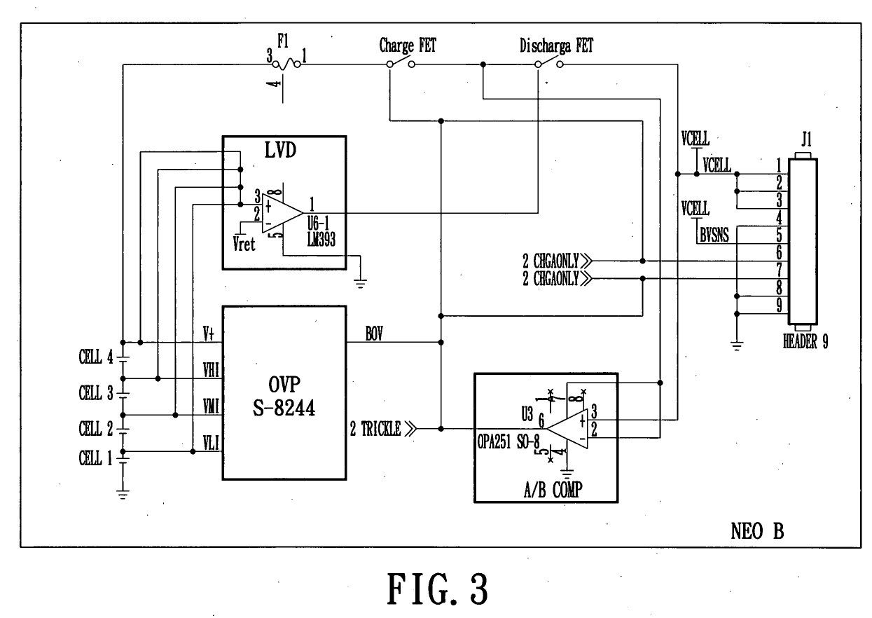

Reference is made to FIGS. 2 and 3 for the main charging system connected to an expanded power subsystem and having a main system and subsystem interface module (A/B Comp including a processor U9). The implementation of this preferred embodiment of the present invention is described in details below. The mobile electronic device output port is a universal serial bus (USB) interface, an RS232 interface, a mobile phone power supply interface connector or an extended connector (which refers to a connector added to the original connector). The connected mobile electronic device is a notebook computer, a PDA, a portable audio/video player or a mobile phone. The power input port is a USB interface, a household electric charging interface or a mobile electric charging interface. The main charging system further comprises a subsystem port (J1-HEADER 9), a main system printed circuit board connected with a subsystem interface module (A/B Comp), and an expanded power subsystem (NEO B). The expanded power system is connected to the basic main system by the expanded power subsystem port. The expanded power subsystem comprises a main system port (J1-HEADER9), a subsystem chargeable/dischargeable battery (CELL1-CELL4), and a subsystem printed circuit board being coupled with the main system port (J1-HEADER9) and the subsystem chargeable/dischargeable battery (CELL1-CELL4). The expanded power subsystem has the following circuit modules: a subsystem and main system interface module (A/B COMP, including a processor U9); a subsystem battery control interface module (LVD, including a processor U6-1); and a subsystem control module (OVP, having a circuit protection contact point V+, VHI, VMI, VLI). The chargeable/dischargeable battery (CELL1-CELL4) has a power surge protection circuit and comprises a control module (power surge protection, OVP) and a battery control interface module (low voltage differential, LVD) connected to the main system printed circuit board. The subsystem chargeable and dischargeable batteries (CELL1-CELL4) have the power surge protection circuit, and the subsystem control module (OVP) and the subsystem battery control interface module (LVD) are connected to the subsystem printed circuit board. The mobile electronic device output port has a mobile electronic device voltage parameter transmission contact point for passing the mobile electronic device charging parameter to the discharging module or further to the control module (OVP). The power input port has a circuit connected to the main system printed circuit board, is connected to the chargeable and dischargeable battery for charging the battery and is connected in parallel with a voltage signal to be transmitted to the charging module or further to the control module (OVP). The main system is connected to a subsystem interface module and is capable of receiving a voltage signal from the expanded power subsystem and also is capable of charging or discharging the expanded power subsystem according to the electric power condition of the expanded power subsystem after the control module is connected. The control module (OVP) has a control function to assist the charging interface module (NPP), the charging module (CHARGER), the discharging module (BOOSTER) and the battery control interface module (LVD) to cope with the requirements for different voltage or current specifications for various different electronic devices as well as the requirements for different specifications for the fixed voltage or current of different power supplies.

It is noteworthy that the present invention has the following advantages:

1. The present invention is applicable for different kinds of electronic devices and thus extending its applications. The present invention is accomplished by entering software operators and integrating a battery module into the printed circuit board of an electronic device to reduce a possible misuse of specifications and enhance the efficiency of charging a battery as to achieve the cost-effectiveness purpose.

2. The present invention integrates the charging and discharging function depending on the actual conditions and also integrates both the charging and discharging functions to maximize the scope of applicability for electronic devices to be used in different situations.

3. The present invention comes with an expansion module to be used conveniently for lowering the equipment cost and providing easy access (such as providing a steady current flow for an important circuit).

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A portable charging system, comprising:
a basic main charging system, including a mobile electronic device charging output port, a power input port, a program update input port, a chargeable/dischargeable battery and a main system printed circuit board electrically coupled to said mobile electronic device charging output port, said power input port, said program update input port and said chargeable/dischargeable battery and including a charge/discharge interface module coupled to said mobile electronic device charging output port and said power input port and capable of managing an input/output signal;
a charging module, coupled to said charge/discharge interface module and capable of managing an electric signal;
a discharging module, coupled to said charge/discharge interface module and capable of managing an electric signal;
a battery control interface module, coupled to said chargeable/dischargeable battery, said charging module or said discharging module and having a battery protection function; and
a control module, having a memory and being capable of updating a control program through said program update input port.

2. The portable charging system of claim 1, wherein said mobile electronic device charging output port is a USB interface, an RS232 interface, a connector of a power connection interface of a mobile phone or a connector for a further expansion, and the connected mobile electronic device is a notebook computer, a PDA, an audio/video player or a mobile phone.

3. The portable charging system of claim 1, wherein said power input port is a USB interface, an RS232 interface, a household charging interface or an automobile charging interface.

4. The portable charging system of claim 1, further comprising a subsystem port, a main system connecting subsystem interface module of said main system printed circuit board, and an expanded power subsystem, wherein said expanded power subsystem has a function of coupling said basic main charging system by said subsystem port, and wherein said expanded power subsystem comprises:
a main system port;
a subsystem chargeable/dischargeable battery; and
a subsystem printed circuit board, electrically coupled to said main system port, subsystem chargeable/dischargeable battery and comprising the following circuit modules:
a subsystem connecting main system interface module;
a subsystem battery control interface module; and
a subsystem control module.

5. The portable charging system of claim 1, wherein said chargeable/dischargeable battery has a power surge protection circuit comprised of said control module and said battery control interface module coupled to said main system printed circuit board.

6. The portable charging system of claim 1, wherein said substance chargeable/dischargeable battery has a power surge protection circuit and said subsystem control module and said subsystem battery control interface system are coupled to said subsystem printed circuit board.

7. The portable charging system of claim 1, wherein said mobile electronic device charging output port has a mobile electronic device voltage setting transmission contact port for passing said mobile electronic device charging parameter to said discharging module and selectively to said control module.

8. The portable charging system of claim 1, wherein said power input port has a circuit of said main system printed circuit board for coupling and charging said chargeable and dischargeable battery and connected in parallel with a voltage signal transmitted to said charging module and selectively to said control module.

9. The portable charging system of claim 4, wherein said main system connecting subsystem interface module is capable of receiving a voltage signal of said expanded power subsystem and capable of adjusting the charge and discharge of said expanded power subsystem according to the electric power condition of said expanded subsystem by an adjusting function after said control module is connected.

10. The portable charging system of claim 1, wherein said control module has a control function for assisting said charging/discharging interface, said charging module, said discharging module and said battery control interface module to meet the requirements for different voltage or current specifications for charging different electronic devices and requirements for different voltage or current specifications for different charging sources.
